(19) United States
(12) Patent Application Publication
(10) Pub. No.: US 2012/0290502 A1
(43) Pub. Date: Nov. 15, 2012

(54) Interprocess Communication Regarding Interest Rates and Spreads

(76) Inventors: Stephen Dickson, (US); Pelham Temple, (US)

(21) Appl. No.: 13/285,427

(22) Filed: Oct. 31, 2011

Related U.S. Application Data
(60) Provisional application No. 61/408,633, filed on Oct. 31, 2010.
(60) Provisional application No. 61/409,698, filed on Nov. 3, 2010.

(51) Int. Cl. G06Q 40/06

(52) U.S. Cl. 705/36 R

(57) ABSTRACT

Various embodiments may relate to determining interest rates for one or more periods, determining interest rates for one or more financial instruments, determining correlations, and/or performing any desired actions. Various other embodiments that may include processes and/or apparatus are described.

### CROSS-REFERENCE TO RELATED APPLICATIONS

This application claims the benefit of U.S. provisional application 61/408,633 to Steve Dickson filed on Oct. 31, 2010, which is hereby incorporated herein by reference. This application claims the benefit of U.S. provisional application 61/409,698 to Steve Dickson filed Nov. 3, 2010, which is hereby incorporated herein by reference.

### FIELD

Some embodiments relate to interest rates and/or spreads

### BACKGROUND

Interest rates have been influenced by central banking decisions. Tradable financial instruments may be influenced by interest rates.

### BRIEF DESCRIPTION OF THE FIGURES

FIG. 1 illustrates an example interface in some embodiments;

FIG. 2 illustrates a second example interface in some embodiments;

FIG. 3 illustrates an example of a cascade on change to one or more interest rates in some embodiments;

FIG. 4 illustrates an example of a cascade off change to one or more interest rates in some embodiments;

FIGS. 5A-5C illustrate some example changes to spreads and/or interest rates in some embodiments;

FIG. 6 illustrates an example system that may be used in some embodiments;

FIG. 7 illustrates an example process that may be performed in some embodiments; and

FIG. 8 illustrates an example process that may be performed in some embodiments.

### DETAILED DESCRIPTION

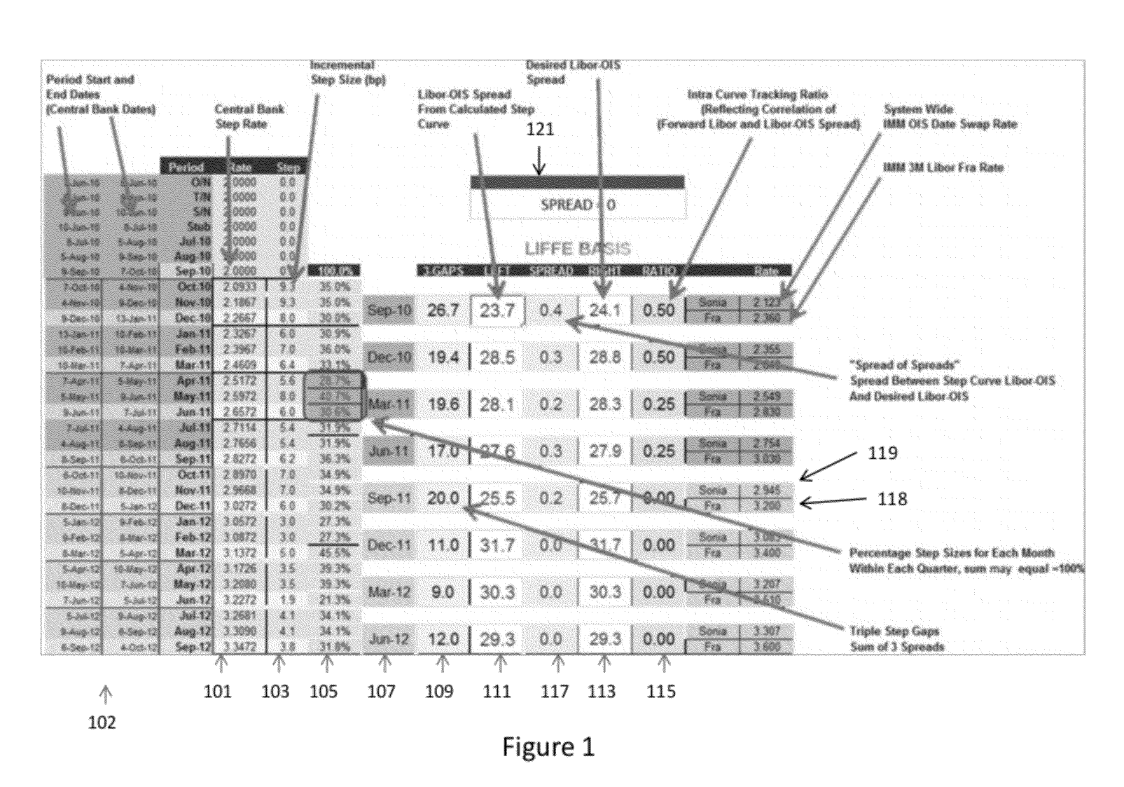

FIG. 1 illustrates an example interface that may be used in some embodiments. It should be recognized that while the examples of FIG. 1 are given in terms of the LIFFE exchange, the SONIA, the LIBOR, and the UK central bank, that any desired exchange (e.g., the Chicago Mercantile Exchange, alternative trading systems, etc.), interest rate instrument (e.g., OIS, FRA, EONIA, fed funds rate OIS, etc.), index (e.g., the NYFR), and/or banking body (e.g., the US federal reserve) may be applicable. Further, it should be recognized that particular dates are given as examples that may correspond to UK (or ECB) central bank dates and/or IMM (International Money Market) dates, but that such dates are non-limiting examples only and that any selection of dates (e.g., Federal Reserve meeting dates, random dates, monthly dates, etc.) may be used in various embodiments. Further, example financial instruments, market data, and indices are also non-limiting examples only. For example, although some embodiments include reference to a LIBOR FRA, other embodiments may include reference to a price of gold, CPI data, a more liquid instrument, other interbank exchange data, bank bond rates, other data that may be indicative of a level of credit cost in a market, and so on. As another example, although some embodiments include reference to a SONIA OIS (Overnight Indexed Swap), other embodiments may include reference to a price of gold, CPI data, a less liquid instrument, government bond rates, other interest rate data, other data that may be indicative of an interest rate. Such data may be the same or different than data indicative of a credit cost. Furthermore, it should be recognized that a particular design and/or layout of an interface is given as a non-limiting example only and that other embodiments may include additional, fewer, no, different, and/or alternative components and/or arrangements.

Determination of Interest Rates

Some embodiments may include determining one or more expected interest rates for one or more respective time frames. FIG. 1 illustrates examples of such interest rates in a form of UK central bank rates (e.g., expected rates) between meetings of the UK central bank indicated in column 101. For example, an interest rate between an October meeting of the central bank and a November meeting of the central bank may be determined to be expected to be 2.0933 in the illustrated example of FIG. 1. The dates for which each rate corresponds are indicated at columns 102 (e.g., from Oct. 7, 2010 to Nov. 4, 2010, which may be referred to as the Oct-10 period may correspond to a 2.0933 rate). Such a determination of interest rates maintaining a constant level between two points in time may be referred to as a step rate or step curve analysis. Although examples of some embodiments may be described with reference to a step curve, it should be recognized that such a feature is not required and that other embodiments may not use a step curve, but rather may use a continuous curve (e.g., a best-fit curve based on data points of various steps), for example. It should be recognized that while a number of interest rates that correspond to central bank meeting periods are shown in FIG. 1, that any desired set of interest rates for any desired periods of time may be used in various embodiments (e.g., dates may correspond to IMM dates, CPI dates, and so on). In some embodiments rather than dates corresponding to some event may not be used, but any dates may be used (e.g., random dates, every day may have a different rate, every minute may have a different rate, etc.).

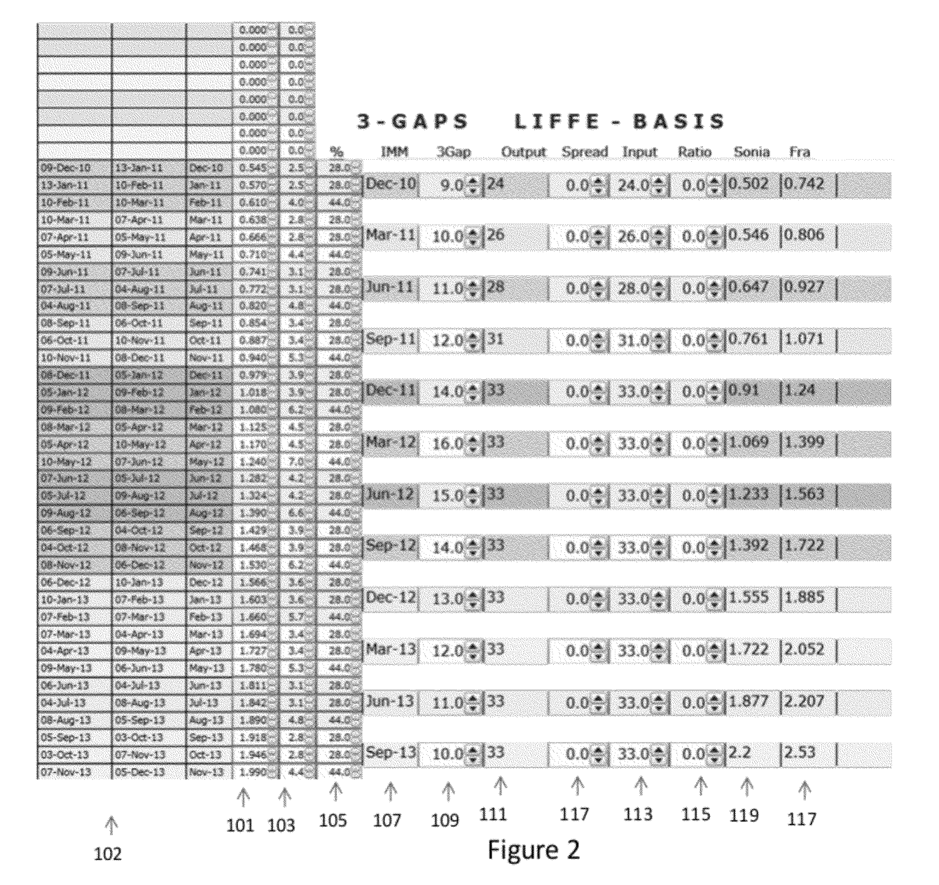

FIG. 2 illustrates another example interface that may be used in some embodiments. The example embodiments of FIGS. 1 and 2 may include same, similar, and/or different information. It should be recognized that any interface having any layout and/or information may be used in various embodiments. Such interfaces may include human-computer interfaces, computer-computer interfaces, display screens (2-d or 3-d screens), touch screens, computers, keyboards, mice, touch pads, tickers, and so on. It should be recognized that some embodiments may include no interface at all.

In some embodiments, a first determination of interest rates may include determining one or more interest rate based on a user input. For example, a user may input respective values for interest rates during one or more of the time frames though an interface such as the one in FIG. 1. Editable fields 101 in FIG. 1 shows an example interface through which such information may be input.

In some embodiments, a first determination of interest rates may include determining one or more interest rates based on one or more market indicators. For example, one or more respective interest rates may be determined (e.g., manually by a user and/or automatically by a computer) based on received information such as indications of current market consensus for interest rates during one or more periods (e.g., market information regarding forwards, swaps, gold, bonds, financial instruments, market data from one or more banks or other estimators of central bank decisions, etc.). One or more respective interest rates may be determined based on one or more received indication of a central bank announcement (e.g., a central bank announcing a target interest rate for a period). Some embodiments may include extrapolating step rates from one or more points of interest rate data (e.g., an announcement of rates for a period by a central bank, an analysis by an investment bank regarding rates for a period, etc.).

It should be recognized that any manner of determining interest rates, a proxy to interest rates, a cost of credit, and so on may be used whether manual, automatic, a combination of the two or otherwise. Such methods may be based on internal and/or external data and/or calculations.

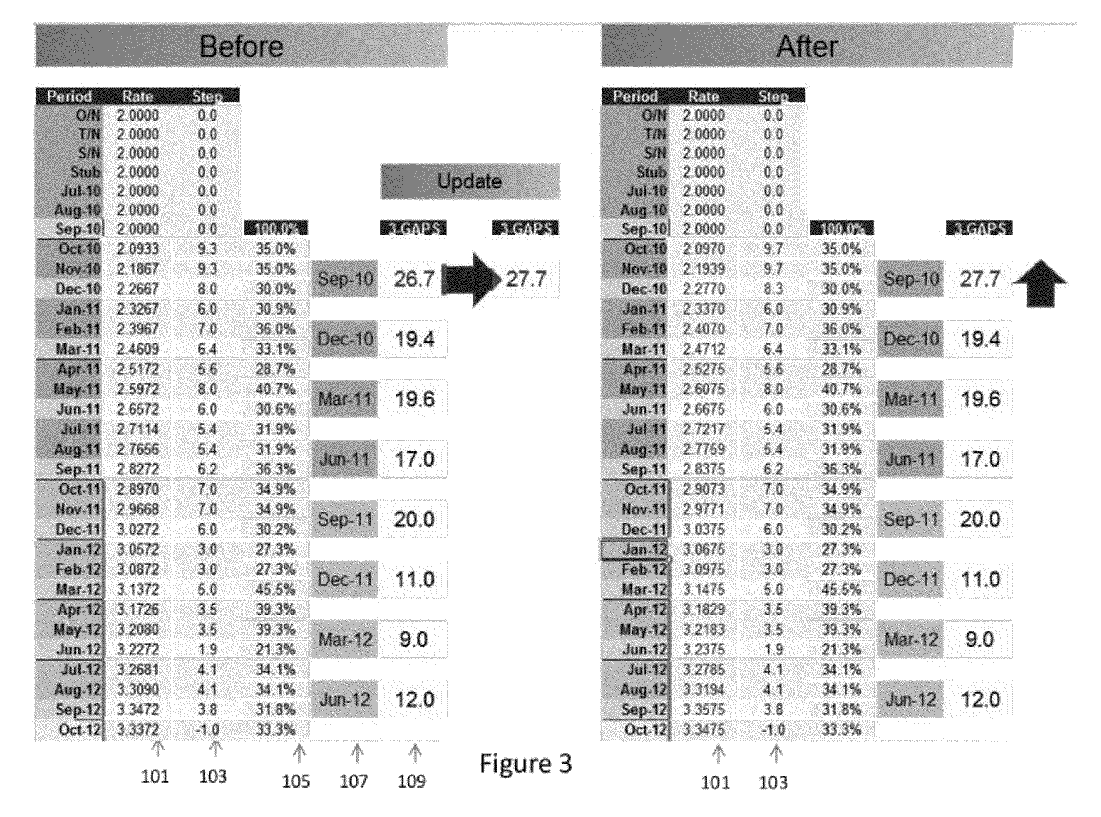

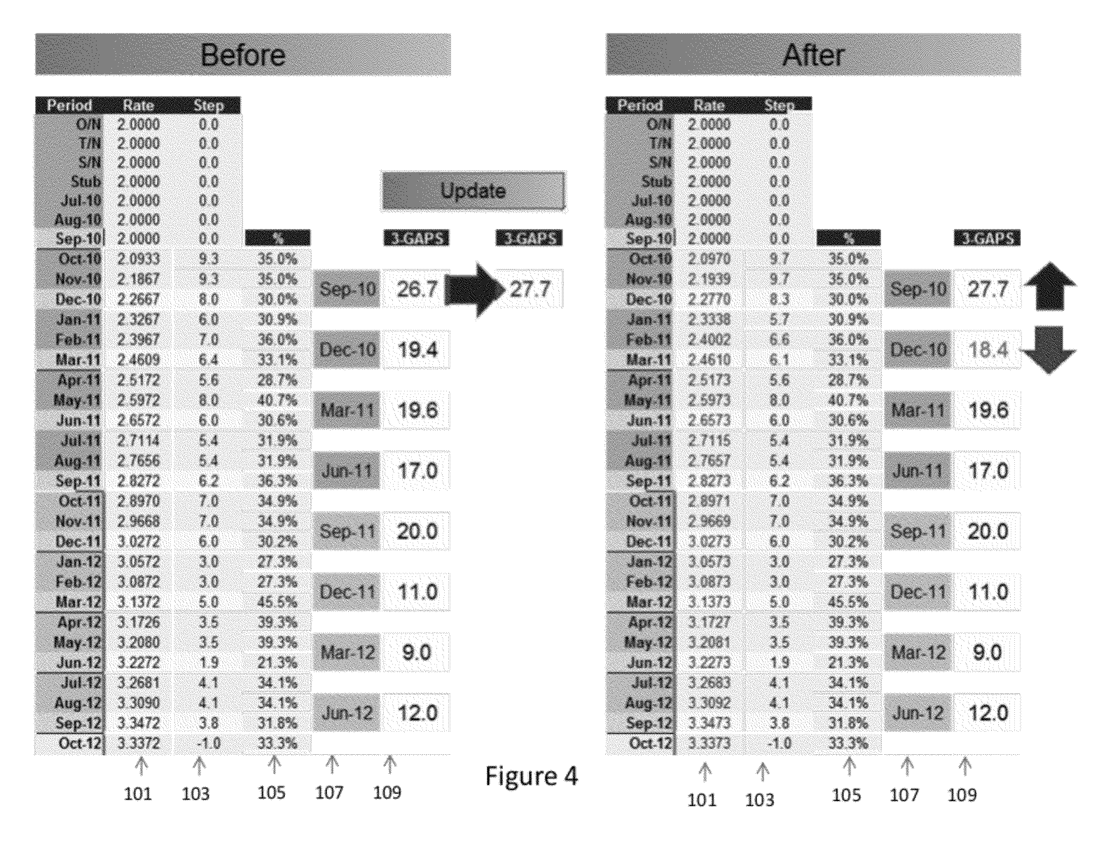

In various embodiments, any desired combination of elements may be used to determine an interest rate. FIGS. 3 and 4 illustrate some examples of a changing of an interest rate. A change to an interest rate may affect one or more other rates or other values discussed elsewhere herein.

FIG. 3 illustrates an example method of a change to an interest rate having such an effect on other information that may be referred to herein as a “cascade on” method. In such a “cascade on” method, a change to one or more interest rates, such as a change to an October 2010 rate, a November 2010 rate and a December 2010 rate from 2.0933, 2.1867, and 2.2667 to 2.097, 2.1939, and 2.2770, respectively, may propagate to later rates (e.g., by increasing each later rate by approximately 1 basis point).

FIG. 4 illustrates another example method of a change to an interest rate having such an effect on other information that may be referred to herein as a “cascade off” method. In such a “cascade off” method, a change to one or more interest rates, such as a change to an October 2010 rate, a November 2010 rate and a December 2010 rate from 2.0933, 2.1867, and 2.2667 to 2.097, 2.1939, and 2.2770, respectively, may have a limited effect on an interest rate curve outside of the changed values. For example, one or more later rates may be adjusted down to offset one or more local increases so that later interest rates are not affected and/or minimally affected. For example, as shown in FIG. 4, a change that causes an October 2010 rate, a November 2010 rate and a December 2010 rate to change from 2.0933, 2.1867, and 2.2667 to 2.097, 2.1939, and 2.2770, respectively, may cause a decrease in rates corresponding to January, February, and March of 2011, but have no effect on the rates corresponding to April 2011 and thereafter.

In some embodiments of “cascade off,” an increase (or decrease) in one time period may cause a decrease (or increase) in subsequent months that decreases in effect over time. For example, an increase of 6 basis points in one time period may cause a decrease of 3 basis in the following time period, a decrease of 2 basis points in the next time period, and a decrease of 1 basis point in the next. Thus, the effect of the increase (or decrease) may gradually decay over subsequent time periods. Such decay may be a linear decay, an exponential decay, geometric decay, decay using discount factors (e.g., time-weighted discount factors, and discount factors as explained herein), other mathematical decay, manually input decay values, or other decay as known to those of skill in the art. In some embodiments, such future effect may not occur.

Some embodiments may include receiving a selection of one or more local interest rate propagation methods (e.g., a “cascade on” and/or a “cascade off”) for determining interest rate change effects. It should be recognized that any method of adjusting information based on a change to an interest rates may be used and that “cascade on” and “cascade off” are given as examples only. Further, any method of determining interest rates from input and/or other information may be used as desired. Similarly, in embodiments that do not include interest rates, any method of determining an effect of a change of one price or other piece of information and/or determining prices and/or other information may be used.

Steps

Some embodiments may include determining one or more expected steps sizes for interest rates between one or more periods. FIG. 1 illustrates examples of such step sizes (e.g., 103) in a form of an expected change in UK central bank rates (as compared to an immediately prior rate) at each of a plurality of UK central bank meeting dates. For example, a November 2010 expected percentage interest rate may include 2.1867 and a December 2010 expected percentage interest rate may include 2.2667. Accordingly, a step size in interest rates occurring at a December 2010 central bank meeting date may include 8 basis points (i.e. 2.2667-2.1867=0.08). It should be recognized that some embodiments may include determining step sizes based on expected interest rates as described. It should be further recognized that other embodiments may include determining expected interest rates based on expected step sizes for one or more periods (e.g. by adding a step size to a prior period's expected interest rate). In some embodiments, step sizes may be changed by a user through an interface such as the one shown in FIG. 1. Such changes may be propagated through to an expected interest rate for one or more periods. Similarly, a change to an interest rate in such an interface may also affect an interest rate step. For example, the examples of FIGS. 3 and 4 may have similar results for a user changing respective interest rate steps (e.g., 9.3 to 9.7, 9.3 to 9.7, and 8.0 to 8.3 respectively) as for users changing respective interest rates such that a combination of interest rates and interest rate steps are consistent with one another. It should be recognized that in some embodiments that do not include interest rates, any method of determining steps of prices or between other information may be used.

Percentage Step Size

Some embodiments may include determining a collection of time frames for which interest rates may be determined (e.g., a collection of time periods between central bank meetings). Such a collection may include a collection of complete time frames, and/or portions of time frames. Some embodiments may include determining a percentage of an expected step in interest rates over the collected time frames that may be attributed to one or more steps for one or more individual time frames within a collection (e.g., column 105). Such percentages may be determined for each time frame that may make up each collection of a plurality of collections. Such collections may include a collection of time frames between some number of central bank dates (e.g., 3), between dates of a financial quarter, between international money market periods (e.g., 3 month periods, 6 month periods, etc.), random dates, and so on as desired.

The example of FIG. 1 shows an example where three monthly time frames between central bank meetings are collected together. Such three period collections may correspond exactly and/or approximately to international money market periods, or other periodic dates relevant to a financial product of interest. It should be recognized that such individual time frames and their collection into three month groupings are given as non-limiting examples only. In other embodiments, no such collection may be made, a different size of time frames may be used, halves may be used instead of quarters, years may be used instead of quarters, months may be used instead of quarters, weeks may be used instead of months, and so on as desired.

In some embodiments, a percentage step size for an individual time frame may be determined based on a total step size for a collection of time frames compared to a step size attributable to the individual time frame. For example, 35% shown for the October 2010 percentage in FIG. 1 may be determined by summing October, November, and December steps sizes (i.e. 9.3+9.3+8=26.6) and dividing an October step size by the sum (i.e. 9.3/26.6×100%=35%). Various other methods of determining such a percentage may be performed as desired. In some embodiments, a user may alter such a percentage through an interface such as that shown in FIG. 1. Such an alteration may propagate through to a step size and/or interest rate as described with respect to FIGS. 3 and 4. Similarly, a change to one or more of a step size and/or an interest rate may also affect a percentage.

In some embodiments, there may be a direct connection between a set of time frames and a collection of those time frames (e.g., a set of months may be grouped to a quarter that starts at the first month and ends at the last month). In some embodiments rather than such a direct connection, a connection may be approximate (e.g., a set of months between respective central bank meetings may roughly correspond to an IMM three month period but the start dates and end dates may not exactly match). In such an example, some information about one or more of the time frames that may be appropriately associated with a collection of the time frames, may not be part of the collection because of such a mismatch of dates (e.g., some days of a last month or first month may not be in a collection). In such an example, some information about one or more time frames that would not otherwise be associated with a collection of time frames may be part of the collection (e.g., some days of a prior or next time frame that are not desired to be part of a collection may be included). In some embodiments, such discrepancies may be ignored. In some embodiments, such discrepancies may be accounted for when determining percentages, and/or other information discussed herein (e.g., by adjusting a weight given to a time frame in accordance with a percentage of time the month is actually in the collection, by adjusting discount rates for a time frame, and so on).

It should be recognized that one or more of an interest rate, an interest rate step, and/or a percentage step size may be determined, entered, and/or adjusted in any manner, which may cause a modification of other effect on one or more of the others. It should be recognized that any periods of time may be used and that any collections of time frames may be used whether or not such collections have a direct correspondence to the time frames. Further, it should be recognized that while examples of collections are given as separate time frames, some embodiments may include overlapping collections, collections within collections, non-continuous collections, and so on.

It should be recognized that step sizes, periods, rates, percentages, collections, and so on are given as examples. Such elements may take alternative form, be excluded, be altered, not be shown, not be included in an interface, and so on in various other embodiments.

IMM 3 Month Examples

Some embodiments may include determining information regarding one or more collection of time frames. Such a collection may correspond to a three month IMM period as illustrated in FIG. 1. For example, FIG. 1 illustrates a plurality of rows (e.g., 107) that correspond to three month IMM periods that have a starting date corresponding to an IMM date in a month identified at a left column of a row (e.g., September 2010) and ending at a three month IMM date after that time. As discussed elsewhere, such dates may or may not correspond directly to central bank dates or other dates of other time frames may be used.

Some embodiments may include determining an expected interest rate change (e.g., 109) over such a collection (e.g., the IMM periods of FIG. 1). As shown in FIG. 1, such interest rate change 109 may be referred to in this example as a “3-GAPS”, which represents a sum of the three steps 103 for a corresponding three-month period. In some embodiments, such an interest rate change may be in a form of an expected number of basis points changed over the entirety of the collection. In some embodiments, such an interest rate change may be determined based on interest rate steps of individual time frames that may make up such a collection, such as between central bank dates discussed elsewhere herein. For example, in some embodiments, an interest rate change for an IMM period that spans three central bank dates may be determined by summing step changes of interest rates for the three central banks dates, and/or subtracting an interest rate for a final central bank period of the IMM period from an initial central bank period of the IMM period.

In some embodiments, such central bank rates may not directly correspond to IMM dates as described elsewhere herein. A set of central bank rates may occur between a start of an IMM period and an end of an IMM period. Each such bank date may correspond to a change in interest rates. For each such change in interest rates that occur during the IMM period, the change may be summed to determine the expected interest rate change over an IMM period.

In some embodiments, a portion of a prior or subsequent month may be included in a determination of a change of interest rate and/or a portion of a first or last month may not be included in such a determination. Such inclusion and/or exclusion in such a determination may be based upon a percentage of a month that may be part of an IMM period (e.g., if a step is 9 basis points for a month and ⅓ of that month is included in the IMM period, then a step of 3 basis points may be included in the IMM interest rate calculation).

In some embodiments, a change to an interest rate, step amount, and/or percentage associated with a month (or other time frame) may affect a calculation of an interest rate change over an IMM period (or other collection of time frames). In some embodiments, a modification by a user to a change in interest rates over an IMM period may cause a change to one or more of a percentage, a step size, and/or an interest rate in a month. For example, a change to an interest rate change over an IMM period may cause a portion of that change to be associated with each month in the IMM period in accordance with a percentage step associated with each month. FIGS. 3 and 4 may be understood as examples of a change to a 3 month IMM period interest rate change having an effect on the interest rates corresponding to the months of the period (e.g., a change from 26.7 to 27.7 for the period may cause a portion of the one basis point change to be attributed to each of the three months that make up the period according to a percentage of the change attributed to for each month as shown). FIGS. 3 and 4 may be understood as an example of a change to either a set of steps and/or rates affecting rates and/or steps and a change over an IMM 3 month period.

Although examples including IMM collections and central bank date steps have been given and shown to interact with one another, it should be understood that these are given as non-limiting examples only. In some embodiments, for example, any dates may be used, collections may not be used, collection information may not be calculated from and/or related to component information (e.g., IMM dates may be determined directly by a user, from analysis, from market data rather than and/or in addition to from interest rate step information, and so on), and so on.

Model Spread

Some embodiments may include determining a first spread (e.g., 111) between two financial instruments. For example, some embodiments may include determining a first spread between a financial instrument tied to a first interest rate measure (e.g., a LIBOR index, a LIBOR FRA, a bank bond, a measure of interbank offer rates, and so on) and a financial instrument tied to a second interest rate measure (e.g., an OIS such as a SONIA OIS, a measure of a central bank rate, a government bank, a swap, a gold price, a CPI index, and so on) during each of the IMM periods and/or other periods desired and discussed elsewhere herein. In some embodiments, a first interest rate measure may include a measure of a rate paid on unsecured interbank deposits (e.g. LIBOR), a measure of credit cost, a measure tied to a stable rate over a time period, and so on. In some embodiments, a second rate may relate to an expectation of overnight interest rates over a period of time, a rate related to a variability of short term interest rates over the period of time, and so on. FIG. 1 shows an example of a first spread determined based on an expected spread between a LIBOR FRA and a SONIA OIS. It should be recognized that examples of financial instruments and spreads are given as non-limiting examples and that other embodiments may include spreads between any desired financial instruments.

Such a first spread may relate to financial instruments that may be associated with an IMM period and/or other period of time (e.g., collection period, step period). In some embodiments, the two financial instruments may include a same period of time (e.g., from a start to an end of an IMM period), and/or a different period of time.

In some embodiments, the two financial instruments may include different periods of time. For example, a LIBOR FRA may be associated with a period of time from one central bank meeting date to another central bank meeting date about three months from the first central bank meeting date, and a SONIA OIS may be associated with a period of time from a start of a three month IMM period to an end of a three month IMM period. In some embodiments, such different time periods may be treated as a same time period, e.g., for purposes of various calculations by embodiments described herein. In some embodiments, such different time periods may be compared and/or converted in any desired way, such as those described elsewhere herein (e.g., associating percentages to time periods), such that a comparison may be made between the two financial instruments despite the difference in time periods. In some embodiments, adjustments in various algorithms and formulas may be made to account for slight differences in the time periods, as known in the art and/or as described herein.

In some embodiments, determining such an expected first spread may include determining such an expected first spread based on interest rates and/or discount rates expected for each of a plurality of central bank dates (and/or other interest rates and/or prices for a plurality of desired time frames). In some embodiments, a log-linear interpolation of interest rate data may be used to determine an expected first spread. In some embodiments, any method of determining a first spread between two financial instruments based on interest rates and/or prices that may relate to one or both of the two financial instruments may be used. For example, a set of discount factors may be used to determine a SONIA OIS based on the equation:

$$( \frac{df ( {t}_{0} )}{df ( {t}_{1} )} - 1 ) \frac{D}{{d}_{j}} \qquad EQ10$$

(where df(t0)=a discount rate at a start of the OIS period, df(t1)=a discount rate at an end of a OIS period, D j equals a number of days in an IMM period, and D equals a number of days in a money market year). Such a value may be subtracted from a LIBOR FRA rate which may be determined based on market data (e.g., received from a data source such as a market), user input, calculation, and so on to determine a spread.

In some embodiments, a change to an interest rate for a month (or time frame), a change to an interest rate for an IMM period (or collection of time frames), a change to a step, and/or a change to a percentage may alter a spread calculation. For example, an increase in an expected interest rate change over an IMM period may cause a decrease in an expected spread. In some embodiments, a change to an expected spread by a user (e.g., through an interface such as in FIG. 1), for example, may cause a change in one or more of an expected change in interest rates over the IMM period, a percentage change in interest rates, a step size of interest rates, and/or interest rates for a month. For example, in some embodiments, an increase in a spread may cause a change in interest rates over an IMM period to decrease. Such a decrease may cause a corresponding change to one or more monthly interest rate related values as discussed elsewhere herein. It should be recognized that various monthly values and/or IMM period values may be interrelated. Accordingly, a change to one or more of such values (such as by a user and/or based on other input) may cause a change in one or more other values according to such a relationship. Any number of solvers may be used to solve relationship equations that mathematically relate such values to the changed value.

It should be recognized that various examples of relationships between values (e.g., interest rates of time frames, interest rates of collections of time frames, steps, percentages, spreads, discount rates, and so on) are given as examples only. Other embodiments may include data and/or financial instruments that relate to one another in same, different, additional, and/or fewer ways. Such relationships may be determined by a user or by a processor, e.g., based on historical analysis, based on a definition of such instruments and/or data, and so on.

For example, in some embodiments, information about two or more financial instruments over a period of time may be determined. Such information may include a price of each of the financial instruments. A relationship between the prices or other information during the period of time may be used to determine an expected relationship between the two or more financial instruments in the future. Such a relationship may be used to determine how an adjustment of one price or value may affect another price or value. It should be recognized that such historical analysis is given as a non-limiting example, and that other embodiments may include other methods, fewer financial instruments, indirect financial instrument pricing (e.g., a relationship between a price and a spread, a spread and another spread, and so on), and/or any alternatives, additions, and/or reductions.

Data Driven Determinations

Some embodiments may include determining a second spread (e.g., 113) between two financial instruments during each of the IMM periods and/or other periods desired and discussed elsewhere herein. The two financial instruments may include the same financial instrument as discussed elsewhere herein with respect to a model spread. Such a second spread in combination with the first spread may allow a user to determine a divergence between two models, may allow one model to drive data in another model, and so on. Such a second spread may be determined based on user input and/or market data. For example, in some embodiments, such a value may be entered into an interface such as FIG. 1 by a user. In some embodiments, such a value may be entered automatically by a processor, e.g., based on market data, a data feed, one or more calculations, etc. In some embodiments, such a determination may be made based on market date such as a close of a prior day, a last trade of a LIBOR and/or a SONIA OIS, a movement of a market for a LIBOR FRA, a movement in a market for another financial instrument (e.g., gold, CPI, bonds, etc.) and so on.

Some embodiments may include determining a correlation (e.g., 115) between a movement of a first financial instrument and a spread between two financial instruments (the two financial instruments may or may not include the first financial instrument). In FIG. 1, for example, such a correlation (e.g., “ratio” 115) includes a correlation between movement in a LIBOR FRA price and a spread between a LIBOR FRA and a SONIA OIS. Such a correlation may be entered by a user, determined (e.g., automatically) based at least in part on historical information, determined (e.g., automatically) based at least in part on market data, and so on. In some embodiments, such a correlation may be greater for IMM periods (or other time frames and/or collections of tie frames) that have a nearer end date and smaller and/or nonexistent for IMM periods that have a later end date and/or start date. In some embodiments, such a correlation may indicate a portion of a change in a price for a LIBOR FRA that may be carried to a second spread value between the LIBOR FRA and a SONIA OIS. For example, a correlation of 0.5 may indicate that for every basis point increase in a LIBOR FRA, a spread between a LIBOR FRA and a SONIA OIS may increase by half a basis point.

Spread of Spreads

Some embodiments may include determining a spread between a first spread and second spread (e.g., 117). For example, a first spread (e.g., a LIBOR vs OIS spread from a calculated step curve) may include 23.7 points and a second spread (e.g., a LIBOR OIS spread target. desired spread, or spread from data) may include 24.1 points. A spread between these spreads may include 0.4 points. A spread may be determined in some embodiments based on a difference between a first spread and a second spread.

Some embodiments may include one or more modes of operation that may impact a way in which a spread of spreads may operate, may be determined, and may be used to determine other values. For example a spread of spreads may be maintained at a desired level (e.g., a level entered by a user, a level determined from historical analysis), a spread of spreads may be kept at zero, a spread of spreads may be allowed to float based on differences in the determinations of the first and second spreads, and so on. The different modes may be selected by a user. In some embodiments, modes may be changed automatically. For example, a mode may be changed upon the occurrence of an event or various conditions (e.g., a user-selected or otherwise predetermined condition), such as one or more values (such as a market measure such as variance and/or market value of a financial instrument) exceeding or dropping below a particular value.

Market Data

Some embodiments may include determining one or more market prices (e.g., 118) for one or more first financial instruments. Such market prices may be determined based on market data that may be received, for example, from an exchange, a data feed, a user, a news aggregator, a website, an internet connection, and so on. A market price may refer to a fixed interest rate related to the instrument. In some embodiments, such market prices may include a current and/or relatively current price for a LIBOR FRA for one or more 3 month IMM periods. Such market data may indicate a most recent price, a bid, an offer, a last trade, etc. for a trade and/or order of such a first financial instrument, e.g., on a financial futures exchange. Changes in such prices may affect one or more other values (e.g., based on a correlation of the price to a spread).

Some embodiments may include determining one or more prices (e.g., 119) for one or more second financial instruments. The one or more prices may refer to a fixed interest rate of the instruments. For example, some embodiments may include determining a price for a SONIA OIS based on a determined LIBOR FRA price and a determined first and/or second spread between a LIBOR FRA and a SONIA OIS. In some embodiments, a user may enter such information, and/or such information may be obtained from market data. Changes in such prices may be affected by and/or affect other information depending on the relationship of such second financial instrument to such other information.

It should be recognized that any number of prices for any number of financial instruments may be included in various embodiments as desired and that any automatic and/or manual method of determining such values may be used.

Spread Determinations

Some embodiments may include adjusting a first spread based on a determination of a second spread (e.g., right to left propagation in FIG. 1). For example, in some embodiments, a second spread may be determined as described elsewhere herein based on user input and/or market data. In some embodiments, in which a spread of spreads is determined to be a fixed number (e.g., 0, 0.4), a first spread may be adjusted from a first determined value based on interest rates, for example, to a second value based on the second spread and a spread of spreads. For example, if a first spread is determined to be 23.6, a spread of spreads is determined to be 0.4 and a second spread is determined to be 24.1, a first spread may be adjusted from 23.6 to 23.7 so that the spread of spreads is maintained. In some embodiments, making such an adjustment to a first spread may cause one or more changes with respect to an interest rate, a collection of a determination of interest rates, step rates, and so on as discussed elsewhere herein. Such adjustments may be performed automatically in some modes of operation by a computing device in response to a change in LIBOR FRA market data causing a change in a second spread. In some embodiments, such a mode of operation may provide insight into how a change in a LIBOR FRA rate may affect interest rate steps.

Some embodiments may include adjusting a second spread based on a determination of a first spread (e.g., left to right propagation in FIG. 1). For example, in some embodiments, a change in a first spread (e.g., based on user input, a change to an interest rate, etc.) may cause a second spread to be adjusted such that a spread of spreads is maintained at a desired level. A change in a second spread may cause a change in a price of a SONIA OIS, a LIBOR FRA, a correlation value, and/or other values. Such adjustments may be performed automatically in some modes of operation by a computing device in response to a change in interest rates, first spread values, and so on. In some embodiments one or more of a SONIA OIS, a LIBOR FRA, and a correlation may be maintained at a constant level and/or a level based on market data and a change to a spread may affect other values that are allowed to float based on model changes. For example, in some embodiments, LIBOR FRA may be obtained from market data, a correlation may be held constant, and a initial price of a SONIA OIS may be obtained from market data; a change to a second spread may cause the initial price of the SONIA OIS to adjust to maintain the spread. It should be recognized that a correlation may be allowed to adjust, a LIBOR FRA may be allowed to adjust, and so on instead of or in addition to a SONIA OIS. In some embodiments, a user may select where data is obtained, what elements are allowed to adjust based on market moves, spread changes, model changes, and so on. A model may function in response to user selection to adjust appropriate values desired by the user selected method of operation. In some embodiments, such a mode of operation may provide insight into how changes in interest rate steps may affect an OIS, correlation, and/or FRA rate.

Some embodiments may include adjusting a spread of spreads based on a determination of a first and/or second spread. For example, in some embodiments, a first spread may be determined, and a second spread may be determined. A spread of spreads may initially be determined based on the first and second spreads. As one or more of the first or second spreads is subsequently changed, a spread of spreads may be re-determined to account for such changes. In some embodiments, such a mode of operation may provide insight into how a change in market data and/or interest rates may cause one pricing and/or spread model to diverge from another pricing and/or spread model. An increase in a spread of spreads may be indicative that an arbitrage opportunity between two such models may exist. In some embodiments, a user may adjust one or more interest rates and/or other values to adjust a spread of spreads if the user desires to converge the two models.

Some embodiments may cause an order to be submitted in response to a spread of spreads reaching a threshold value (e.g., to take advantage of an arbitrage opportunity). For example, if a spread of spreads reaches a threshold level, a SONIA OIS may be purchased and a LIBOR FRA may be sold; a LIBOR FRA may be sold, and a SONIA OIS may be purchased; both instruments may be purchased, both instruments may be sold, one instrument may be purchased, one instrument may be sold, and so on. Multiple thresholds may exist and trigger different types of orders. For example, when a spread is large, purchases may be made, and when a spread decreases, those purchases may be sold. As a spread gets larger, a larger position may be taken. Rather than a discrete threshold, a continuous calculation may be made (e.g., as spread increases, trading may increase in linear, non-linear, etc.). It should be recognized that a spread value may trigger one or more orders being submitted to one or more exchanges through one or more communication networks as desired in any manner.

It should be recognized that although examples herein may be given in terms of interest rates and/or particular financial instruments, that such examples are non-limiting and that various embodiments may include any desired spreads, any number of spreads, and number of spreads of spread, any interest rates, rates, prices, and so on having any desired relationships.

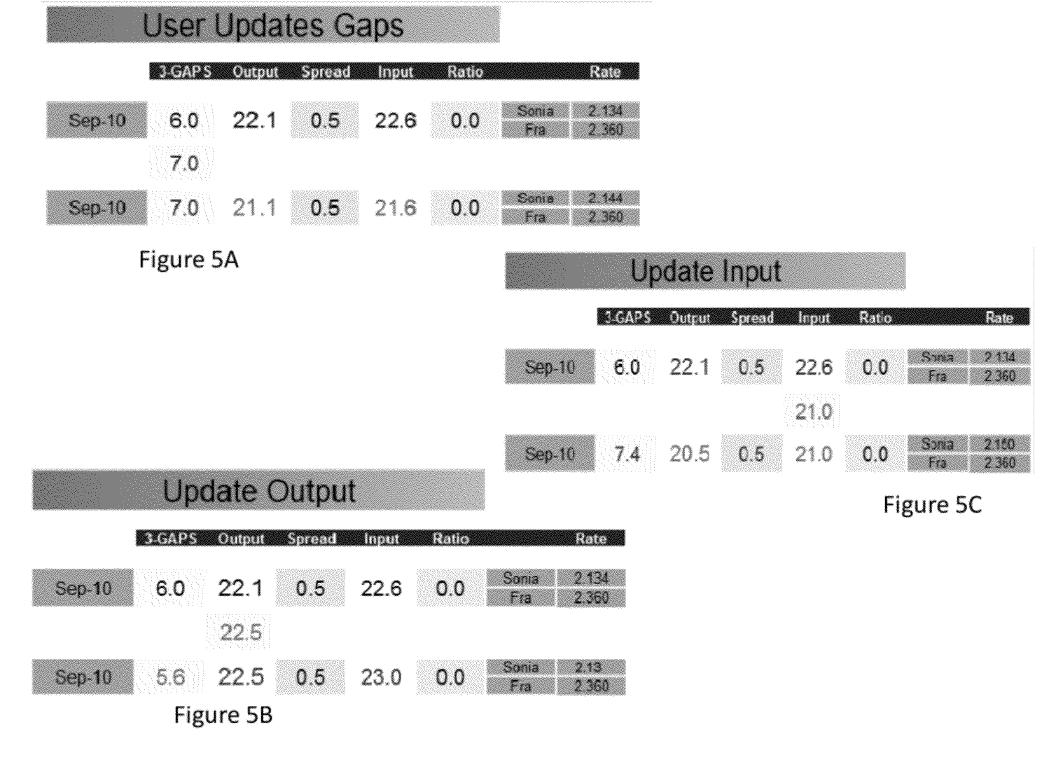

FIG. 5A illustrates an example of a change to an interest rate over a period corresponding to an IMM period from 6 basis points to 7 basis points. Such a change may be caused by a user input, historical data, a change to a second spread, a change to a first spread, a change to a spread of spreads, a change to a LIBOR FRA, a change to a correlation, and so on (e.g., depending on a mode of operation). In some embodiments such as when a user changes the value manually, the change may cause a first spread to change from 22.1 to 21.1. In one example of a mode of operation, such a change in the first spread causes a second spread to change from 22.6 to 21.6 so that a spread of spreads may be maintained at 0.5. A SONIA OIS may also change from 2.144 to 2.134. Further changes that may not be shown include changes related to interest rates for months between central bank dates that may underlie the interest rate over the IMM period. Such an example shows a correlation and a LIBOR FRA being maintained but a SONIA OIS being allowed to adjust. It should be recognized that this is an example only and that other embodiments may include other modes of operation that allow other adjustments and/or maintaining of values.

FIG. 5B illustrates an example of a change of a first spread from 22.1 to 22.5. Such a change may be caused by a user input, historical data, a change to a second spread, a change to a spread of spreads, a change to a LIBOR FRA, a change to a correlation, a change to an interest rate over an IMM period, and so on (e.g., depending on a mode of operation). In some embodiments, such as when a user changes the first spread manually, the change may cause an interest rate over an IMM period to change from 6 basis points to 5.6 basis points. In one example of a mode of operation, such a change in the first spread may cause a second spread to change from 22.6 to 23 so that a spread of spreads may be maintained at 0.5. Further changes that may not be shown include changes related to interest rates for months between central bank dates. Similar to the Figure of 5A, such a change may propagate through to correlation, SONIA OIS, LIBOR FRA, and so on.

FIG. 5C illustrates an example of a change of a second spread from 22.6 to 21.0. Such a change may be caused by a user input, historical data, a change to a first spread, a change to a spread of spreads, a change to a LIBOR FRA, a change to a SONIA OIS, a change to a correlation, a change to an interest rate over an IMM period, and so on (e.g., depending on a mode of operation). In one example of a mode of operation, such a change in the first spread may cause a first spread to change from 22.1 to 20.5 so that a spread of spreads may be maintained at 0.5. In some embodiments, such a change in a first spread may cause a change in an interest rate over an IMM period from 6.0 to 7.4. Further changes that may not be shown include changes related to interest rates for months between central bank dates that may underlie the interest rate over the IMM period, recalculated from, for example 6.0 basis points to 7.4 basis points. In some embodiments, if the change in the second spread was caused by a change to a LIBOR FRA, the change to the LIBOR FRA may have also have an effect on the first spread so that a change to a spread of spreads and/or other values may take into account the change in the first spread as well.

It should be recognized that the examples of FIGS. 5A, 5B, and 5C are given as non-limiting examples only. Such examples may include maintaining a spread of spreads, but as discussed elsewhere some embodiments may include other modes of operation do not include such maintaining of a spread of spreads.

Menu and Modes

Some embodiments may include one or more menus (e.g., 121) that may allow a user to select from among one or more mode of operation options. Some example modes may include: 1) an automatic mode in which a spread of spreads is equal to zero such that a change to one value that causes a change to one spread may propagate to another spread and cause other values to subsequently be changed so that the spread of spreads is maintained at zero, 2) an automatic mode in which a spread of spreads is equal to some user entered number such that a change to one a value that causes a change to one spread may propagate to another spread and cause other values to be changed so that the spread of spreads is maintained at the user entered number, 3) a manual mode in which a spread of spreads is allowed to change in response to changes in one spread or another and such changes are not propagated to other values, 4) a left to right mode (in reference to FIG. 1), in which changes in a first spread may affect changes in a second spread to maintain a spread of spreads, but changes in a second spread do not have such an effect on the first spread to maintain the spread of spreads, 5) a right to left mode (in reference to FIG. 1) in which changes in a second spread may affect changes in a first spread to maintain a spread of spreads, but changes in a first spread do not have such an effect on the second spread to maintain the spread of spreads, and/or 6) an elastic automatic mode that may smooth potentially noisy market data (e.g., LIBOR FRA data) such as by implementing a FRA butterfly algorithm, a market data smoothing algorithm, and/or otherwise reducing distortions in a shape of a LIBOR FRA rate curve.

In some embodiments, a user may select a mode of operation from such a menu, establish one or more values for the mode of operation through an interface, enter any desired information through an interface (e.g., interest rates, correlation values), and so on. In response to such a choice, a system may determine values and update an interface according to the selection.

It should be recognized that examples of modes are given as non-limiting examples only and that other embodiment may include any desired mode that may allow any effect on operation and/or relationship between any desired values.

Pricing Examples

Some embodiments may include determining an expected interest rate and/or price for a financial instrument. Such a financial instrument may include a financial instrument associated with one or more interest rates (e.g., an interest rate swap based on LIBOR and/or central bank rates). Determining an interest rate for such a financial instrument may include determining a fixed rate portion of a financial instrument such as an interest rate swap. For example, one interest rate swap may include providing a fixed rate payment to one party from a second party and providing a floating rate payment from the other party to the one party. Determining an expected rate may include determining a fixed rate payment that may be expected to be a fair market rate for a particular interest rate swap over a desired period of time. Such a determination may be made, in some embodiments based, at least in part, on one or more other interest rate values and/or discount rate values. Some embodiments may include offering a financial instrument for sale based on such a calculation and/or offering to buy a financial instrument with better rates if they are being offered.

Some embodiments may include determining information identifying one or more characteristics of a financial instrument for which an interest rate is desired (e.g., start date, end date). Such information may be entered into an interface, such as a trading interface by a trader, by a customer of the trader, based on a desired schedule of characteristics, and so on. In some embodiments, a rate may be output to a trader, customer of the trader, a ticker, a display, an interface, a computing device, and so on. In other embodiments, the output may be to an electronic trading system to be used, for example, as an indicative price, a trading price and/or to provide source pricing for further calculations on similar financial instruments.

Some embodiments may include determining a starting date and an ending date for a financial instrument such as one based on interest rates. For example, some embodiments may receive an indication of a customer's interest in entering into an interest rate swap between a particular start date and end date. One example period may include a forward Jun. 7, 2011 to Mar. 7, 2012 period. An expected market price of an interest rate for such a financial instrument (e.g., an interest rate swap or a specific dated FRA) may be determined based on a discount rate for a starting date, a discount rate for an end date, and a length of time of the period. One or more such discount rates may be determined from interest rates and/or interest rate steps that may be determined as described elsewhere herein.

In one example, a series of discount rates for each of a plurality of dates (e.g., each of a set of central bank dates) may be determined. Such discount rate may include a rate used in determining a present value of a future cash flow. For example, a discount rate for a first period may be determined based on (a prior period's discount rate)/{1+(a current periods interest rate)*[(a number of days in a current period)/(a number of days in a year)]}. Discount rates may be determined for each period tracked by some embodiments (e.g., a next year, a next two years, any number of time frames for which interest and/or other data may be available or otherwise determined, etc.). In some modes of operation, data regarding financial instrument prices may drive interest rate data so that such calculations may be made for any desired dates.

In some embodiments, a period for a financial instrument may have a beginning and/or end date that may be the same as a central bank date (or other time frames as discussed elsewhere herein) for which a discount rate is determined. In some embodiments one or more of a start date and/or an end date may be different than such central bank dates. If a date is the same, a discount rate determined for the date may be used. If a date is different, a discount rate for the different date may be determined based on a log-linear interpolation of the discount rates and/or interest rates for the other dates. Other methods of such a determination may be used in some embodiments, such as using a nearby date, other interpolation methods and/or estimation techniques, and so on. Accordingly, a discount rate for each of a start date and an end date may be determined. In the forward Jun. 7, 2011 to Mar. 7, 2012 example with rates as shown in FIG. 1, a starting discount rate may include 0.97792 and an ending discount rate may include 0.95698.

In some embodiments, an interest rate for a financial instrument may be determined based on such discount rates for a start and end date. For example, in some embodiments a rate may be determined such that the rate is equal to [(discount rate at the start date)/(discount rate at the end date)−1]×(number of days in the period)/(number of days in a money market year). In the Jun. 7, 2011 to Mar. 7, 2012 example with rates as shown in FIG. 1, a rate of 2.915 may be determined.

Accordingly, market movements that may affect interest rates and therefore discount rates may be used to determine rates to offer customers for such financial instruments. It should be recognized that various methods of determining such a rate may be used. It should be recognized that various financial instruments may be used. Some embodiments may include adding a markup to a rate to price in some element of risk, liquidity, and/or convenience charge.

Some embodiments may include determining a price and/or rate for such a financial instrument based on a series of LIBOR FRAs and/or other market data. For examples, such LIBOR FRAs may establish a step curve similar to the interest rate step curve described elsewhere herein (e.g., with different periods of time and values). In some embodiments, the LIBOR FRAs used for such a step analysis may be adjusted based on one or more of a first spread and/or second spread to approximate a SONIA OIS and/or central bank rate. Such a step curve and/or rates may be used to determine a discount rate for a start and end period similar to determining discount rates based on the interest rates of a central bank as described elsewhere herein. Such discount rates may be used to determine a rate and/or price similar to the use of discount rates described elsewhere herein. Accordingly, pricing and/or rate information based on one or more models may be available.

It should be recognized that examples of financial instruments, characteristics of financial instruments, dates of financial instruments, rates and/or price determinations for financial instruments, discount rates, determination of discount rates, and so on are given as non-limiting examples only. Various embodiments may include desired elements and methods that may be based on particular relationship between values and/or financial instruments.

Calculation Examples

Various calculations may be performed in one or more embodiments. Various examples of calculations are described elsewhere herein. Some further examples that may be used in some embodiments may be found in this portion. It should be recognized that example calculations are non-limiting and that other embodiments may include alternative, additional, and/or fewer calculations as desired. For example, other embodiments may include other calculations and/or determination based on relationships and/or data used in such embodiments.

Some embodiments may include determining an interest rate step between two periods based on a difference between an interest rate during each period. Some embodiments may include determining an interest rate in a next period based on an interest rate of a first period by adding an expected interest rate step for entering the next period (e.g.,

$${R}_{i} = {R}_{i - 1} + \frac{{S}_{i}}{100} \qquad ( EQ20 )$$

where R=an interest rate and s=a step size). Some embodiments may include determining an interest rate for a time frame based on a percentage of a total interest rate change over a collection of time frames attributable to the time frame and a total interest rate change over the collection (e.g.,

Rᵢ=Rᵢ₋₁+PᵢG(i) (EQ30)

where G=a total change in interest rate and P=a percentage change attributed to a time frame). Some embodiments may include determining a change in interest rate from one time frame to a next time frame based on interest rate for each time frame (e.g.,

Sᵢ=100(Rᵢ−Rᵢ₋₁) (EQ40)

in basis points). Some embodiments may include determining a change in interest rate from one time frame to another time frame based on a percentage of a total interest rate change over a collection of time frames attributable to the time frame and a total interest rate change over the collection; e.g.,

Sᵢ=PᵢG(i) (EQ50)

Some embodiments may include determining a percentage of an interest rate change in a collection of periods that is attributed to a period within the collection based on a division of an interest rate step for the period divided by a sum of interest rate steps for the collection of periods (e.g.,

$$\begin{matrix}{P}_{i} = \frac{( {R}_{i} - {R}_{i - 1} )}{G ( i )} \\ or & ( EQ60 ) \\ {P}_{i} = \frac{{S}_{i}}{G ( i )} . & ( EQ70 )\end{matrix}$$

Some embodiments may include determining a change of interest rates over a collection of time periods during which interest rates may change based on a summation of interest rate changes during those periods; e.g.,

Σₙ₌₀²Sᵢ₊ₙ=G(i)=Gⱼ (EQ80)

Some embodiments may include determining a discount rate based on one or more interest rates associated with one or more times and/or time periods. Such a discount rate may include a rate used in determining a present value of a future cash flow. For example, a discount rate for a first period may be determined based on (a prior period's discount rate)/{1+(a current periods interest rate)*[(a number of days in a current period)/(a number of days in a year)]} (e.g.,

$${df}_{k} = \frac{{df}_{k - 1}}{( 1 + \frac{{r}_{i} {d}_{k}}{D} )} \qquad ( EQ90 )$$

where df=a discount rate, r=a rate for a time frame, d=a number of dates in a step, and D=a number of days in a money market year (e.g., 365, 360), d0 may equal 1). Some embodiments may include determining one or more spreads and/or other discount rates based on a log-linear (and/or other) interpolation of discount rates and/or interest rates.

Some embodiments may include determining a first spread. Such a determination may be based on one or more discount rates and/or time periods (e.g.,

$${X}_{j} = 100 ( {f}_{j} - ( \frac{df ( {t}_{0} )}{df ( {t}_{1} )} - 1 ) \frac{D}{{d}_{j}} ) \qquad ( EQ100 )$$

where X is a first spread, df(t0) is a discount rate at a beginning of a period, df(t1) is a discount rate at an end of a period, and f is a LIBOR FRA rate).

Some embodiments may include determining one or more spreads based on an initial spread value, a correlation of spread, a change in a value of a financial instrument, and/or a change in a value of a financial instrument. For example, some embodiments, may include determining an initial value of a spread at 24.1 (e.g., based on user input, calculated LIBOR FRA value, and/or present and/or historical market data), determining a correlation of 0.5 (e.g., based on user input and/or historical market data), and determining an initial value of a LIBOR FRA at 2.360 (e.g., based on user input and/or historical market data). In some embodiments, an increase of 1 basis point in the LIBOR FRA to 2.370 may cause an increase in a half basis point in the spread to 24.6 (e.g.,

Zⱼ=Zⱼ+100Δfⱼrⱼ (EQ110)

where r is a measure of a correlation between the movement in the FRA and a movement in the spread, Z=a second spread, and delta f is a movement in the FRA.). In some embodiments, a value of a SONIA OIS may be adjusted to maintain the spread in view of the FRA adjustment and spread adjustments (e.g., s=f−z).

Some embodiments may include determining a second spread based on a LIBOR FRA and SONIA OIS price (e.g.,

Zi=100(fⱼ−sⱼ) (EQ120)

where s equals a price of a SONIA OIS). Some embodiments may include determining a second spread based on a spread of spreads and a first spread (e.g.,

Yⱼ=Zⱼ−Xⱼ (EQ130)

where Y equals a spread of spreads.

Some embodiments may include determining a financial instrument price. For example, a SONIA OIS value may be determined by adding a first and/or second spread to a LIBOR FRA. Some embodiments may include determining a spread based on another spread and/or a spread of spreads. For example, a first spread may be determined based on a second spread plus or minus a spread of spreads. As another example, a second spread may be determined based on a first spread plus or minus a spread of spreads. Some embodiments may include determining a spread of spreads based on a difference between a first spread and a second spread.

In some embodiments, a FRA value may be determined based on a spread or change in spread. For example, if a SONIA is maintained at a constant value of 100, and a spread is adjusted from 10 to 15, a FRA may be adjusted to 115 from 110 to account for the new spread (e.g., f=f+delta Z or s=s−Z). such an example may occur where there is no correlation between FRA and spread and/or in embodiments where there is such a correlation.

In some embodiments where there is a correlation, a SONIA may also be adjusted when a spread is adjusted. For example, if there is a correlation of 0.5, and a spread is adjusted from 10 to 15, a FRA may be adjusted from 110 to 120 (e.g., f=delta z/R); a SONIA may be adjusted from 100 to 105 (e.g., s=f−Z). In other embodiments, a SONIA maybe held constant at 100 and the FRA may take the entire adjustment. Accordingly, a correlation may be accounted for in a solver by adjusting one or more values.

Some embodiments may include determining a rate for an interest rate swap based on discount rates and/or interest rates. For example, an interpolation of discount rates for a set of dates may be used to determine discount rates for dates that are not in the set. Any applicable interpolation method may be used, including but not limited to, Straight Line, Cubic Spline, Log Linear and/or Monotone convex. Such determined discount rates may be used to determine a rate for the swap based on a length of a period for the swap. For example, in some embodiments a rate may be determined such that the rate is equal to [(discount rate at the start date)/(discount rate at the end date)−1]×(number of days in the period)/(number of days in an IMM year).

Some examples may include equations that may include subscripts such as i and or j. An i subscript may represent a central bank of other time frame period, and a j may represent a collection of time frame period such as an IMM period. It should be recognized that central bank and/or IMM period may differ based on country. For example, a UK and/or EU central bank may meet 36 times for each 12 IMM periods (e.g., 3 month IMM periods) and a US central bank may meet 24 times for each 12 IMM periods (e.g., 3 month IMM periods).

Some embodiments may include one or more solvers processing one or more relationships between values. Such solvers may act simultaneously to solve separate and/or related equations. Such solvers may include computer program processes and/or threads.

Data Examples

Some embodiments may include providing information, such as pricing information through a trader's desktop, a computerized trading system, a computer network, and so on. For example, in some embodiments, on demand interest rates, and/or interest rate swap pricing/rate may be provided. As another example, some embodiment may include publishing a plurality of interest rate swap pricing as market data that may be viewed by a plurality of market participants. Such interest rate swap pricing may be presenting through a ticker, a data feed, a data base, and/or any other collection of interest rate pricing information for one or more interest rate swaps. Such interest rates swaps may have any combination of start and end dates. Such data may be updated in response to interest rate movements, financial instrument price movements, and/or any other change to any other data as described elsewhere here.

Processes and/or Apparatus

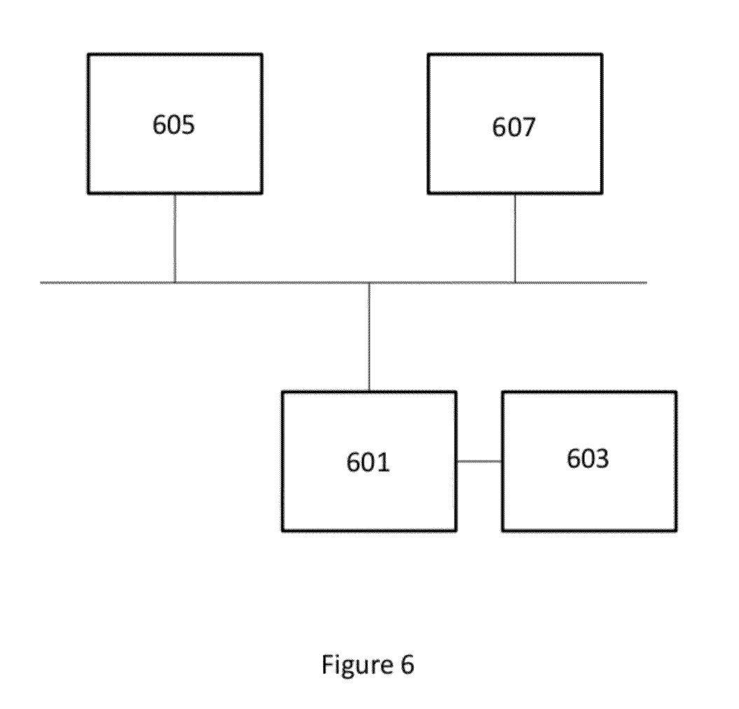

FIG. 6 illustrates an example system. Such a system may include a computing device 601 (e.g., a broker's computer, a general purpose computing device, etc.). Such a system may include an interface 603 (e.g., a computer monitor, anything through which a user interface may be displayed). Such a system may include a data source 605 (e.g., a source of market information, a news source, a financial analysis source, etc.). Such a system may include a marketplace 607 (e.g., an alternative trading system, an electronic exchange, etc.). In some embodiments, one or more components and/or modules such as these may communicate with one another through one or more communication networks. For example, market data may be received from data source 605 through the Internet by computing device 601. Computing device 601 may use a bus to co control an interface 603 to display information through a user interface. Computing device 601 may communicate through the internet to provide trading orders to marketplace 607.

Element 601 may include any type of computing device such as a standalone device, a mobile device, a server, a cloud based system, and so on. Such a device may include any number of components such as other computing devices, servers, communication links, and so on.

Element 603 may include any manner of interface with a user (e.g., a display, a touch screen, a keyboard, a monitor, a motion sensor, a mouse, a 3d display, and so on). Such a interface may receive information to provide a user, provide such information to the user (e.g., such as in the form of user interfaces of FIG. 1), receive input from the user, and so on.

Element 605 may include any source of information, such as an electronic data feed from a data provider, a web site, a new organization, and so on. Any number of such sources may be used (e.g., a feed from central bank meetings, a feed regarding market prices, a feed from financial analysis estimating interest rates, etc.).

Element 607 may include any type of financial exchange. Such an exchange may facilitate the execution of one or more trades that may involve financial instruments related to interest rates. Such an exchange may accept orders, match orders, execute trades, and so on.

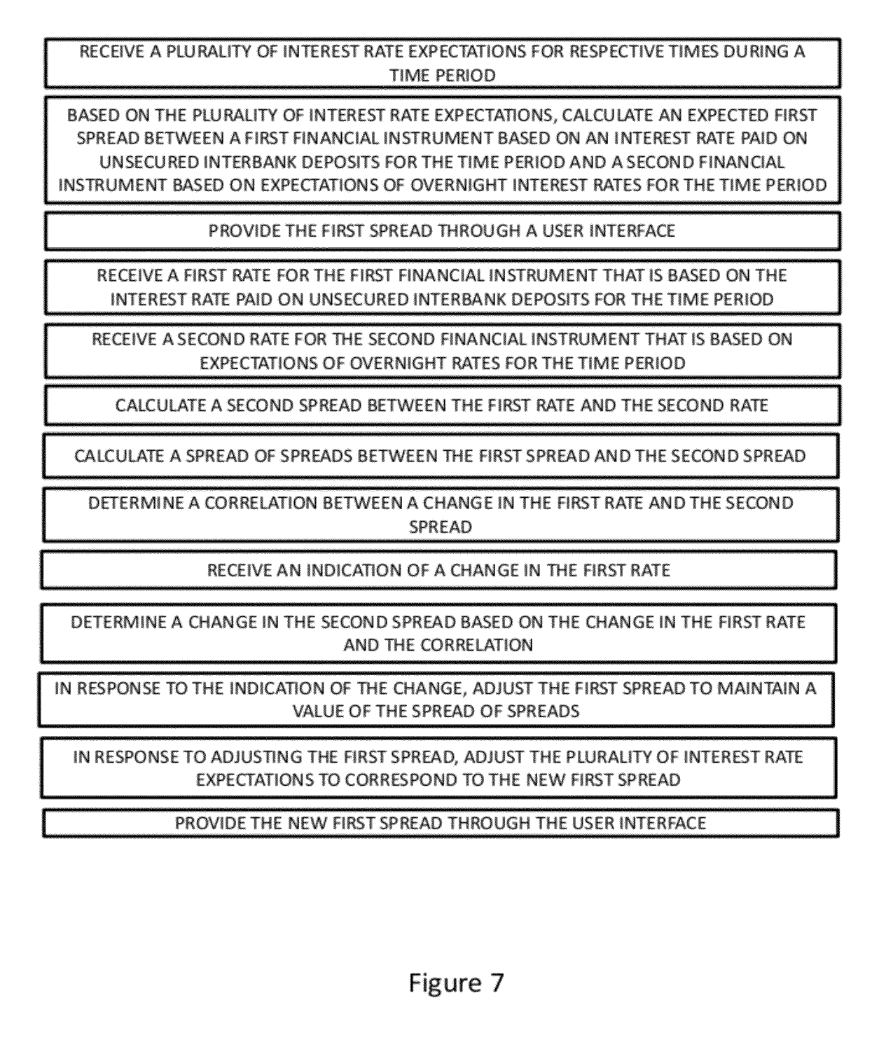

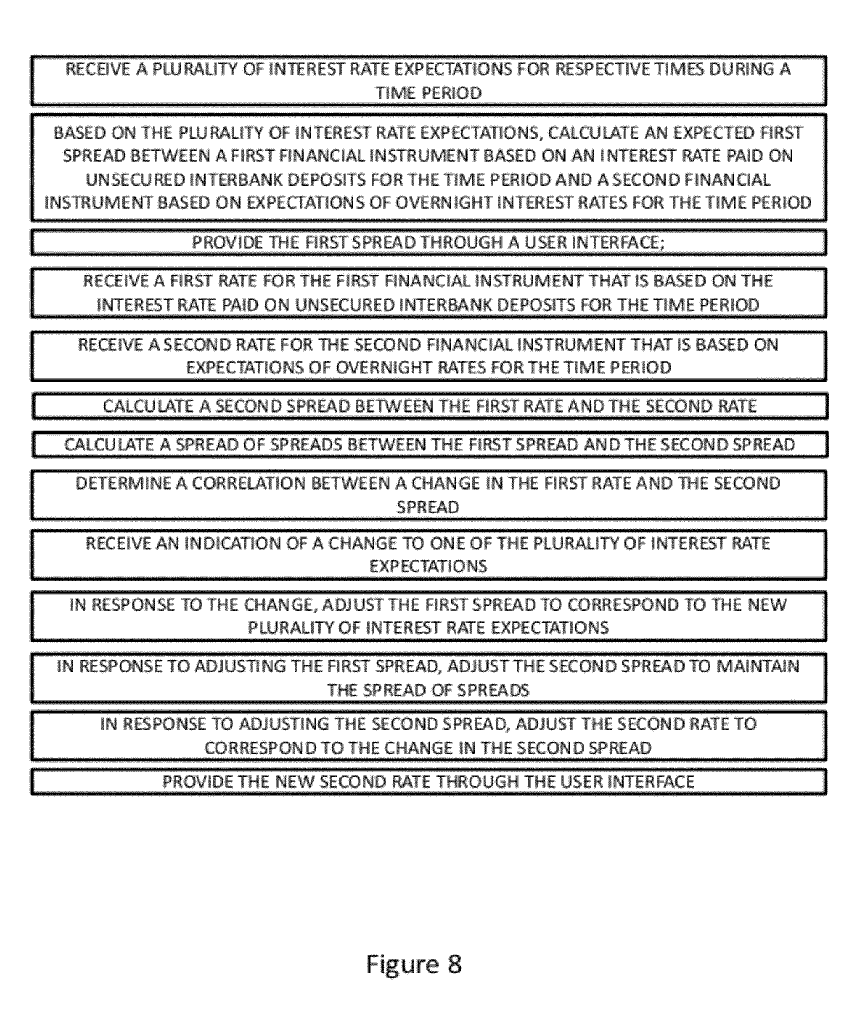

It should be recognized that the example of FIG. 6 is given as a non-limiting example only. Other embodiments may include any elements in any combinations communicating in any manner. For example, some embodiments may include a cloud-based distributed system, a peer-to-peer system, and so on. As another example, some components may be a same component (e.g., a interface and device may be a same element; a data source and a marketplace may be a same element; a device may be part of a marketplace and/or data source, and so on). In some embodiments, one or more elements may perform one or more actions and or perform one or more process (e.g., those of FIG. 7 and/or FIG. 8) individually and/or in combination with one or more other elements.

FIG. 7 illustrates an example process. Such a process, one or more actions of such a process, and/or one or more actions related to such a process may be performed by a computing device such as a trading interface, a trader's workstation, an electronic exchange, and so on. Such a process may allow a user to compare spreads between two financial instruments and/or indices. Such a comparison may include a model spread and a data driven spread so that a user can determine if there is divergence between a model from a data driven spread. Such a process may allow a user to determine pricing for a financial instrument based on an interaction between models. For example, a user may determine a rate for an interest rate swap based on the interaction between a data driven model and a mathematical model of LIBOR-OIS spreads. Such data may be provided as price quotes, and/or data feeds to be used by a broker or trader to price a new instrument and/or as a feed for a financial data system to be published for user information. Such data may be used to determine trading opportunities such as when a data model diverges from a mathematical model. In some embodiments, a medium may have stored on it a plurality of instructions that when executed cause a computing device to perform such a method.

Some embodiments may include receiving a plurality of interest rate expectations for respective times during a time period. Various examples of such expectations are given herein. Such expectations may be entered by a user, received from a central bank statement of interest rates, received from a data source, and so on. Such interest rates may correspond to central bank periods in some embodiments.

Some embodiments may include based on the plurality of interest rate expectations, calculating an expected first spread between a first financial instrument based on an interest rate paid on unsecured interbank deposits for the time period and a second financial instrument based on expectations of overnight interest rates for the time period. In some embodiments, the first financial instrument includes a forward rate agreement. In some embodiments, the forward rate agreement is based on LIBOR. In some embodiments, the second financial instrument includes an overnight indexed swap. In some embodiments, the overnight index swap is based on SONIA, EONIA, Federal Reserve fund effective rates, and/or any index. In some embodiments, the times include times relative to central bank meetings. In some embodiments, the time period includes a time relative to an international money market date. In some embodiments, times and/or time periods may be selected by a user, programmed to correspond to important dates that may be relevant to trading and/or interest rates.

Various examples of calculating a first spread are given herein. In some embodiments, calculating the first spread includes determining discount rates for each of the times; determining a first ratio of an initial and final discount rate and a second ratio of a number of days in the time period and a number of days in a money market year; and based on the first rate, the first ratio, and the second ratio, determining the first spread. Various examples of calculating discount rates and using ratios to determine spreads are given herein. It should be recognized that such methods are non-limiting and that any manner of calculating any element may be used. Some embodiments may include providing the first spread through a user interface. For example, FIG. 1 may be used to display such information to a user.

Some embodiments may include receiving a first rate for the first financial instrument that is based on the interest rate paid on unsecured interbank deposits for the time period. In some embodiments, receiving the first rate includes receiving the first rate from a market data provider. For example, a market data provider may provide an indication of a current rate for a LIBOR FRA for each of a plurality of time periods. In some embodiments, a user may identify such a rate (e.g., based on data, based on desire, as a theoretical rate, based on calculation, etc.). In some embodiments, a rate may indicate a fixed interest rate for a FRA.

Some embodiments may include receiving a second rate for the second financial instrument that is based on expectations of overnight rates for the time period. In some embodiments, receiving the second rate includes receiving the second rate from a market data provider. For example, a market data provider may provide an indication of a current rate for a SONIA OIS for each of a plurality of time periods. In some embodiments, a user may identify such a rate (e.g., based on data, based on desire, as a theoretical rate, based on calculation, etc.). In some embodiments, a rate may indicate a fixed interest rate of an OIS.

Some embodiments may include calculating a second spread between the first rate and the second rate. Such a spread may be calculated by subtracting or otherwise comparing the two rates. A spread may include a difference between the two rates.

Some embodiments may include calculating a spread of spreads between the first spread and the second spread. For example, the difference between the two spreads may be determined based on the two spreads. Such a difference may indicate a divergence between a model and a reality.

Some embodiments may include determining a correlation between a change in the first rate and the second spread. In some embodiments, determining the correlation includes at least one of receiving a user input correlation, and determining the correlation based on historical data illustrating the correlation. For example, historic data may be monitored over a period of time to determine such a correlation over some amount of time. Such a correlation may be adjusted over time based on new data. Such a correlation may be entered by a person. Some embodiments may not include such a correlation at all and/or may determine a zero correlation. Correlations may be determined for each time period and may be different for each time period (e.g., correlations may be smaller or larger as time is more distant from the present).

Some embodiments may include receiving an indication of a change in the first rate. For example, a user may alter such a rate through a user interface, a system may receive data from a data source, and so on.

Some embodiments may include determining a change in the second spread based on the change in the first rate and the correlation. Various examples of determining a changed spread are given herein. For example, if a rate increases from an original rate, the spread may increase. In some embodiments, a second rate may be adjusted in connection with the first rate and the correlation. Such adjustment may diverge from a market rate to follow a correlation model. Some embodiments may not include such a correlation model.

Although the first rate is described as changing, in some embodiments, a second rate may change in addition to and/or as an alternative to the first rate. For example, a data feed of an OIS market may be analyzed to determine such a change. Such a change may have an effect on a spread similar to the effect of a first rate change.

Some embodiments may include in response to the indication of the change, adjusting the first spread to maintain a value of the spread of spreads. Examples of adjusting a spread to maintain a spread of spreads are given herein.

Some embodiments may include in response to adjusting the first spread, adjusting the plurality of interest rate expectations to correspond to the new first spread. Examples of adjusting interest rate expectations based on a spread are given herein. For example, a solver may be used to solve one or more equations that relate a spread to a set of interest rate expectations. Such equations may relate to a first rate and/or other data driven rate.

In some embodiments, the plurality of interest rate expectations includes second expectations for second respective times during a plurality of other time periods that are distinct from the time period. In some embodiments, the process includes calculating respective first spreads between respective first financial instruments based on an interest rate paid on unsecured interbank deposits for each of the respective other time periods and a second financial instrument based on expectations of overnight interest rates for each of the respective other time periods; and providing each of the respective first spreads through the user interface. FIG. 1 illustrates various expectations over various time periods.

In some embodiments, the process includes adjusting the second expectations based on the adjustment to the plurality of interest rate expectations; and adjusting one of the respective first spreads that corresponds to a second time period in response to the adjusted second expectations. For example, a “cascade on” and/or “cascade off” method may be used to adjust interest rates. Such methods are discussed herein to describe methods that allow a interest rate change to affect other interest rate expectations. If such other interest rate expectations are affected, because such interest rate expectations relate to spread calculations, other spreads that are so related may be affected. A solver may be used to solve equations relating interest rate expectations for any number of time periods to spreads. Such solving may occur in response to any number of interest rate expectations changes having any effect and/or no effect on other interest rate expectations.

In some embodiments the process includes in response to adjusting the one of the respective first spreads, adjusting another second spread that corresponds to the second time period to maintain a second spread of spreads for the second time period; and in response to adjusting the other second spread, adjusting a rate for a third financial instrument based on an interest rate paid on unsecured interbank deposits for the second time period. In some embodiments, the process includes submitting an order for the third financial instrument in response to a determination that the adjusted third rate differs from a rate available on a financial market. For example, in response to any first spread changing, a second spread for a same time period may be changed to maintain a spread of spreads for that time period. Such a change may have an effect on one or more rates (e.g., through an equation relating a second spread to such a rate).

In some embodiments, the process includes if a second correlation between the third rate and the other second spread is determined to be non-zero, in response to adjusting the other second spread, adjusting an other second first rate for a fourth financial instrument based on expectations of overnight interest rates for the second time period in accordance with the second correlation to maintain the second spread. Various examples of a correlation relating one or more rates to a spread are given herein.

It should be recognized that a change to one element may affect any number of other elements in a model such as described herein. Such a change may be accounted for by solving one or more equations in accordance with a model and/or method of operation.

Some embodiments may include providing the new first spread through the user interface. For example, an interface of FIG. 1 may be used to display such information.

In some embodiments, the process may include receiving an indication of characteristics of a desired instrument; providing an interest rate quote for the desired instrument based on the adjusted interest rate expectations. In some embodiments, the characteristics include a start and end date of a contract, and determining the interest rate quote includes determining the interest rate quote based on a length of time between the dates and a ratio between an adjusted interest rate expectation corresponding to at least one of the start and end date. In some embodiments, providing the interest rate quote includes submitting an order to an electronic marketplace. Various examples of determining interest rates fare given herein.

FIG. 8 illustrates an example process. Such a process, one or more actions of such a process, and/or one or more actions related to such a process may be performed by a computing device such as a trading interface, a trader's workstation, an electronic exchange, and so on. Such a process may allow a user to compare spreads between two financial instruments and/or indices. Such a comparison may include a model spread and a data driven spread so that a user can determine if there is divergence between a model from a data driven spread. Such a process may allow a user to determine pricing for a financial instrument based on an interaction between models. For example, a user may determine a rate for an interest rate swap based on the interaction between a data driven model and a mathematical model of LIBOR-OIS spreads. Such data may be provided as price quotes, and/or data feeds to be used by a broker or trader to price a new instrument and/or as a feed for a financial data system to be published for user information. Such data may be used to determine trading opportunities such as when a data model diverges from a mathematical model. In some embodiments, a medium may have stored on it a plurality of instructions that when executed cause a computing device to perform such a method.

Some embodiments may include receiving a plurality of interest rate expectations for respective times during a time period. Various examples of such rates, times, and time periods are given herein.

Some embodiments may include based on the plurality of interest rate expectations, calculating an expected first spread between a first financial instrument based on an interest rate paid on unsecured interbank deposits for the time period and a second financial instrument based on expectations of overnight interest rates for the time period. Various examples of such instruments and calculations are given herein.

Some embodiments may include providing the first spread through a user interface. Various examples of interfaces are provided herein.

Some embodiments may include receiving a first rate for the first financial instrument that is based on the interest rate paid on unsecured interbank deposits for the time period. Various examples of receiving such information are described herein.

Some embodiments may include receiving a second rate for the second financial instrument that is based on expectations of overnight rates for the time period. Various examples of receiving such information are described herein.

Some embodiments may include calculating a second spread between the first rate and the second rate. Various examples of determining such spreads are given herein.

Some embodiments may include calculating a spread of spreads between the first spread and the second spread. Various examples of determining such spreads are given herein.

Some embodiments may include determining a correlation between a change in the first rate and the second spread. Various examples of determining such correlations are given herein.

Some embodiments may include receiving an indication of a change to one of the plurality of interest rate expectations. For example, a user may enter a change to a rate expectation, data regarding a central bank decision may be received, a financial analyst may predict a rate change, a rate change may be calculated based on data driven events (e.g., a change to a first rate).

Some embodiments may include in response to the change, adjusting the first spread to correspond to the new plurality of interest rate expectations. Various examples of changing a spread in response to a interest rate change are given herein.

In some embodiments, the plurality of interest rate expectations includes second expectations for second respective times during a plurality of other time periods that are distinct from the time period, and the process includes calculating respective first spreads between respective first financial instruments based on an interest rate paid on unsecured interbank deposits for each of the respective other time periods and a second financial instrument based on expectations of overnight interest rates for each of the respective other time periods; and providing each of the respective first spreads through the user interface. Various examples of such information for a plurality of times periods are described herein and show, for example in FIG. 1.

In some embodiments, the process includes adjusting the second expectations based on the new interest rate expectations; and adjusting one of the respective first spreads that corresponds to a second time period in response to the adjusted second expectations. Various examples of adjusting interest rates based on spreads and interaction between one interest rate expectation and other interest rate expectations are described herein.

In some embodiments, the process includes in response to adjusting the one of the respective first spreads, adjusting another second spread that corresponds to the second time period to maintain a second spread of spreads for the second time period; and in response to adjusting the other second spread, adjusting a rate for a third financial instrument based on an interest rate paid on unsecured interbank deposits for the second time period. Various examples of an interest rate expectation affecting one or more spreads are given herein (e.g., through solving one or more sets of equations that describe relations of elements of a model).

Some embodiments may include in response to adjusting the first spread, adjusting the second spread to maintain the spread of spreads. Various examples of adjusting a spread in response to another spread adjustment are given herein.

Some embodiments may include in response to adjusting the second spread, adjusting the second rate to correspond to the change in the second spread. In some embodiments, the process may include if the correlation is non-zero, in response to adjusting the second spread, adjust the first rate based on the correlation to maintain the second spread. Various examples of adjusting a rate in response to a spread change are given herein

Some embodiments may include providing the new second rate through the user interface. Various examples of providing information through a user interface are provided herein.

It should be recognized that FIG. 7 and FIG. 8 are non-limiting examples of processes. Such processes are non-exclusive and may be used together in any combination. Various embodiments may include one or more actions of such processes in any order, combination, and so on. Some embodiments may include alternative, fewer, no, additional, different, and so on processes.

Various examples are given in terms of financial instruments, but it should be recognized that embodiments are not so limited. For example, financial instruments may reflect index values but may not be exactly in line with such index values. For examples, a LIBOR rate and a financial instrument that relates to LIBOR may not be a same value, a SONIA and a financial instrument related to a SONIA may not have a same value. Some embodiments may use a financial instrument as a proxy to an index. Some embodiments may us a financial instrument instead of an index. Some embodiments may use an index instead of a financial instrument. Some embodiments may use an index as a proxy to a financial instrument. Some embodiments may use a financial instrument in part and an index in part. Some embodiments may account for the divergence between an index and a financial instrument.

### I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. Incorporation by Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

Example Embodiments

The following should be interpreted as example embodiments and not as claims.

A. An apparatus comprising: a computing device; and a non-transitory medium having stored thereon a plurality of instructions that when executed by the computing device cause the computing device to: receive a plurality of interest rate expectations for respective times during a time period; based on the plurality of interest rate expectations, calculate an expected first spread between a first financial instrument based on an interest rate paid on unsecured interbank deposits for the time period and a second financial instrument based on expectations of overnight interest rates for the time period; provide the first spread through a user interface; receive a first rate for the first financial instrument that is based on the interest rate paid on unsecured interbank deposits for the time period; receive a second rate for the second financial instrument that is based on expectations of overnight rates for the time period; calculate a second spread between the first rate and the second rate; calculate a spread of spreads between the first spread and the second spread; determine a correlation between a change in the first rate and the second spread; receive an indication of a change in the first rate; determine a change in the second spread based on the change in the first rate and the correlation; in response to the indication of the change, adjust the first spread to maintain a value of the spread of spreads; in response to adjusting the first spread, adjust the plurality of interest rate expectations to correspond to the new first spread; and provide the new first spread through the user interface.

A.1. The apparatus of claim A, in which the first financial instrument includes a forward rate agreement. A.1.1. The apparatus of claim A.1, in which the forward rate agreement is based on LIBOR. A.2. The apparatus of claim A, in which the second financial instrument includes an overnight indexed swap. A.2.1. The apparatus of claim A.2, in which the overnight index swap is based on SONIA. A.3. The apparatus of claim A, in which determining the first spread include: determining discount rates for each of the times; determining a first ratio of an initial and final discount rate and a second ratio of a number of days in the time period and a number of days in a money market year; and based on the first rate, the first ratio, and the second ratio, determining the first spread. A.4. The apparatus of claim A, in which the times include times relative to central bank meetings. A.5. The apparatus of claim A, in which the time period includes a time relative to an international money market date.

A.6. The apparatus of claim A, in which the plurality of interest rate expectations includes second expectations for second respective times during a plurality of other time periods that are distinct from the time period, and in which the computing device is caused to: calculate respective first spreads between respective first financial instruments based on an interest rate paid on unsecured interbank deposits for each of the respective other time periods and a second financial instrument based on expectations of overnight interest rates for each of the respective other time periods; and provide each of the respective first spreads through the user interface. A.6.1. The apparatus of claim A.6, in which the computing device is caused to: adjust the second expectations based on the adjustment to the plurality of interest rate expectations; and adjust one of the respective first spreads that corresponds to a second time period in response to the adjusted second expectations. A.6.2. The apparatus of claim A.6.1, in which the computing device is caused to: in response to adjusting the one of the respective first spreads, adjust another second spread that corresponds to the second time period to maintain a second spread of spreads for the second time period; and in response to adjusting the other second spread, adjust a rate for a third financial instrument based on an interest rate paid on unsecured interbank deposits for the second time period. A.6.2.1. The apparatus of claim A.6.2, in which the computing device is caused to: submit an order for the third financial instrument in response to a determination that the adjusted third rate differs from a rate available on a financial market. A.6.2.2. The apparatus of claim A.6.2, in which the computing device is caused to: if a second correlation between the third rate and the other second spread is determined to be non-zero, in response to adjusting the other second spread, adjust an other second first rate for a fourth financial instrument based on expectations of overnight interest rates for the second time period in accordance with the second correlation to maintain the second spread.

A.7. The apparatus of claim A, in which the computing device is caused to: receive an indication of characteristics of a desired instrument; provide an interest rate quote for the desired instrument based on the adjusted interest rate expectations. A.7.1. The apparatus of claim A.7, in which the characteristics include a start and end date of a contract, and in which determining the interest rate quote includes determining the interest rate quote based on a length of time between the dates and a ratio between an adjusted interest rate expectation corresponding to at least one of the start and end date. A.7.2. The apparatus of claim A.7, in which providing the interest rate quote includes submitting an order to an electronic marketplace. A.8. The apparatus of claim A, in which determining the correlation includes at least one of receiving a user input correlation, and determining the correlation based on historical data illustrating the correlation. A.9. The apparatus of claim A, in which receiving the first rate includes receiving the first rate from a market data provider.

B. An apparatus comprising: a computing device; and a non-transitory medium having stored thereon a plurality of instructions that when executed by the computing device cause the computing device to: receive a plurality of interest rate expectations for respective times during a time period; based on the plurality of interest rate expectations, calculate an expected first spread between a first financial instrument based on an interest rate paid on unsecured interbank deposits for the time period and a second financial instrument based on expectations of overnight interest rates for the time period; provide the first spread through a user interface; receive a first rate for the first financial instrument that is based on the interest rate paid on unsecured interbank deposits for the time period; receive a second rate for the second financial instrument that is based on expectations of overnight rates for the time period; calculate a second spread between the first rate and the second rate; calculate a spread of spreads between the first spread and the second spread; determine a correlation between a change in the first rate and the second spread; receive an indication of a change to one of the plurality of interest rate expectations; in response to the change, adjust the first spread to correspond to the new plurality of interest rate expectations; in response to adjusting the first spread, adjust the second spread to maintain the spread of spreads; in response to adjusting the second spread, adjust the second rate to correspond to the change in the second spread; and provide the new second rate through the user interface.

B.1. The apparatus of claim B, in which the first financial instrument includes a forward rate agreement. B.1.1. The apparatus of claim B.1, in which the forward rate agreement is based on LIBOR. B.2. The apparatus of claim B, in which the second financial instrument includes an overnight indexed swap. B.2.1. The apparatus of claim B.2, in which the overnight index swap is based on SONIA. B.3. The apparatus of claim B, in which determining the first spread include: determining discount rates for each of the times; determining a first ratio of an initial and final discount rate and a second ratio of a number of days in the time period and a number of days in a money market year; and based on the first rate, the first ratio, and the second ratio, determining the first spread. B.4. The apparatus of claim B, in which the times include times relative to central bank meetings. B.5. The apparatus of claim B, in which the time period includes a time relative to an international money market date.

B.6. The apparatus of claim B, in which the plurality of interest rate expectations includes second expectations for second respective times during a plurality of other time periods that are distinct from the time period, and in which the computing device is caused to: calculate respective first spreads between respective first financial instruments based on an interest rate paid on unsecured interbank deposits for each of the respective other time periods and a second financial instrument based on expectations of overnight interest rates for each of the respective other time periods; and provide each of the respective first spreads through the user interface. B.6.1. The apparatus of claim B.6, in which the computing device is caused to: adjust the second expectations based on the new interest rate expectations; and adjust one of the respective first spreads that corresponds to a second time period in response to the adjusted second expectations. B.6.2. The apparatus of claim B.6.1, in which the computing device is caused to: in response to adjusting the one of the respective first spreads, adjust another second spread that corresponds to the second time period to maintain a second spread of spreads for the second time period; and in response to adjusting the other second spread, adjust a rate for a third financial instrument based on an interest rate paid on unsecured interbank deposits for the second time period.

B.7. The apparatus of claim A, in which the computing device is caused to: receive an indication of characteristics of a desired instrument; provide an interest rate quote for the desired instrument based on the new interest rate expectations. B.7.1. The apparatus of claim B.7, in which the characteristics include a start and end date of a contract, and in which determining the interest rate quote includes determining the interest rate quote based on a length of time between the dates and a ratio between an adjusted interest rate expectation corresponding to at least one of the start and end date. B.7.2. The apparatus of claim B.7, in which providing the interest rate quote includes submitting an order to an electronic marketplace. B.8. The apparatus of claim B, in which the computing device is caused to: submit an order for the second financial instrument in response to a determination that the new second rate differs from a rate available on a financial market. B.9. The apparatus of claim B, in which the computing device is caused to: If the correlation is non-zero, in response to adjusting the second spread, adjust the first rate based on the correlation to maintain the second spread. B.10. The apparatus of claim B, in which determining the correlation includes at least one of receiving a user input correlation, and determining the correlation based on historical data illustrating the correlation. B.11. The apparatus of claim B, in which receiving the first rate includes receiving the first rate from a market data provider.

What is claimed is:

1. An apparatus comprising:
a computing device; and
a non-transitory medium having stored thereon a plurality of instructions that when executed by the computing device cause the computing device to:
receive a plurality of interest rate expectations for respective times during a time period;
based on the plurality of interest rate expectations, calculate an expected first spread between a first financial instrument based on an interest rate paid on unsecured interbank deposits for the time period and a second financial instrument based on expectations of overnight interest rates for the time period;
provide the first spread through a user interface;
receive a first rate for the first financial instrument that is based on the interest rate paid on unsecured interbank deposits for the time period;
receive a second rate for the second financial instrument that is based on expectations of overnight rates for the time period;
calculate a second spread between the first rate and the second rate;
calculate a spread of spreads between the first spread and the second spread;
determine a correlation between a change in the first rate and the second spread;
receive an indication of a change in the first rate;
determine a change in the second spread based on the change in the first rate and the correlation;
in response to the indication of the change, adjust the first spread to maintain a value of the spread of spreads;
in response to adjusting the first spread, adjust the plurality of interest rate expectations to correspond to the new first spread; and
provide the new first spread through the user interface.

2. The apparatus of claim 1, in which the first financial instrument includes a forward rate agreement.

3. The apparatus of claim 2, in which the forward rate agreement is based on LIBOR.

4. The apparatus of claim 1, in which the second financial instrument includes an overnight indexed swap.

5. The apparatus of claim 4, in which the overnight index swap is based on SONIA.

6. The apparatus of claim 1, in which calculating the first spread includes:
determining discount rates for each of the times;
determining a first ratio of an initial and final discount rate and a second ratio of a number of days in the time period and a number of days in a money market year; and
based on the first rate, the first ratio, and the second ratio, determining the first spread.

7. The apparatus of claim 1, in which the times include times relative to central bank meetings.

8. The apparatus of claim 1, in which the time period includes a time relative to an international money market date.

9. The apparatus of claim 1, in which the plurality of interest rate expectations includes second expectations for second respective times during a plurality of other time periods that are distinct from the time period, and in which the computing device is caused to:
calculate respective first spreads between respective first financial instruments based on an interest rate paid on unsecured interbank deposits for each of the respective other time periods and a second financial instrument based on expectations of overnight interest rates for each of the respective other time periods; and
provide each of the respective first spreads through the user interface.

10. The apparatus of claim 9, in which the computing device is caused to:
adjust the second expectations based on the adjustment to the plurality of interest rate expectations; and
adjust one of the respective first spreads that corresponds to a second time period in response to the adjusted second expectations.

11. The apparatus of claim 9, in which the computing device is caused to:
in response to adjusting the one of the respective first spreads, adjust another second spread that corresponds to the second time period to maintain a second spread of spreads for the second time period; and
in response to adjusting the other second spread, adjust a rate for a third financial instrument based on an interest rate paid on unsecured interbank deposits for the second time period.

12. The apparatus of claim 11, in which the computing device is caused to:
submit an order for the third financial instrument in response to a determination that the adjusted third rate differs from a rate available on a financial market.

13. The apparatus of claim 11, in which the computing device is caused to:
if a second correlation between the third rate and the other second spread is determined to be non-zero, in response to adjusting the other second spread, adjust an other second first rate for a fourth financial instrument based on expectations of overnight interest rates for the second time period in accordance with the second correlation to maintain the second spread.

14. The apparatus of claim 1, in which the computing device is caused to:
receive an indication of characteristics of a desired instrument;
provide an interest rate quote for the desired instrument based on the adjusted interest rate expectations.

15. The apparatus of claim 14, in which the characteristics include a start and end date of a contract, and in which determining the interest rate quote includes determining the interest rate quote based on a length of time between the dates and a ratio between an adjusted interest rate expectation corresponding to at least one of the start and end date.

16. The apparatus of claim 14, in which providing the interest rate quote includes submitting an order to an electronic marketplace.

17. The apparatus of claim 1, in which determining the correlation includes at least one of receiving a user input correlation, and determining the correlation based on historical data illustrating the correlation.

18. The apparatus of claim 1, in which receiving the first rate includes receiving the first rate from a market data provider.

19. An apparatus comprising:
a computing device; and
a non-transitory medium having stored thereon a plurality of instructions that when executed by the computing device cause the computing device to:
receive a plurality of interest rate expectations for respective times during a time period;
based on the plurality of interest rate expectations, calculate an expected first spread between a first financial instrument based on an interest rate paid on unsecured interbank deposits for the time period and a second financial instrument based on expectations of overnight interest rates for the time period;
provide the first spread through a user interface;
receive a first rate for the first financial instrument that is based on the interest rate paid on unsecured interbank deposits for the time period;
receive a second rate for the second financial instrument that is based on expectations of overnight rates for the time period;
calculate a second spread between the first rate and the second rate;
calculate a spread of spreads between the first spread and the second spread;
determine a correlation between a change in the first rate and the second spread;
receive an indication of a change to one of the plurality of interest rate expectations;
in response to the change, adjust the first spread to correspond to the new plurality of interest rate expectations;
in response to adjusting the first spread, adjust the second spread to maintain the spread of spreads;
in response to adjusting the second spread, adjust the second rate to correspond to the change in the second spread; and
provide the new second rate through the user interface.

20. The apparatus of claim 19, in which the first financial instrument includes a forward rate agreement.

21. The apparatus of claim 20, in which the forward rate agreement is based on LIBOR.

22. The apparatus of claim 19, in which the second financial instrument includes an overnight indexed swap.

23. The apparatus of claim 22, in which the overnight index swap is based on SONIA.

24. The apparatus of claim 19, in which calculating the first spread includes:
determining discount rates for each of the times;
determining a first ratio of an initial and final discount rate and a second ratio of a number of days in the time period and a number of days in a money market year; and
based on the first rate, the first ratio, and the second ratio, determining the first spread.

25. The apparatus of claim 19, in which the times include times relative to central bank meetings.

26. The apparatus of claim 19, in which the time period includes a time relative to an international money market date.

27. The apparatus of claim 19, in which the plurality of interest rate expectations includes second expectations for second respective times during a plurality of other time periods that are distinct from the time period, and in which the computing device is caused to:
calculate respective first spreads between respective first financial instruments based on an interest rate paid on unsecured interbank deposits for each of the respective other time periods and a second financial instrument based on expectations of overnight interest rates for each of the respective other time periods; and
provide each of the respective first spreads through the user interface.

27. The apparatus of claim 26, in which the computing device is caused to:
adjust the second expectations based on the new interest rate expectations; and
adjust one of the respective first spreads that corresponds to a second time period in response to the adjusted second expectations.

28. The apparatus of claim 26, in which the computing device is caused to:
in response to adjusting the one of the respective first spreads, adjust another second spread that corresponds to the second time period to maintain a second spread of spreads for the second time period; and
in response to adjusting the other second spread, adjust a rate for a third financial instrument based on an interest rate paid on unsecured interbank deposits for the second time period.

29. The apparatus of claim 19, in which the computing device is caused to:
receive an indication of characteristics of a desired instrument;
provide an interest rate quote for the desired instrument based on the new interest rate expectations.

30. The apparatus of claim 29, in which the characteristics include a start and end date of a contract, and in which determining the interest rate quote includes determining the interest rate quote based on a length of time between the dates and a ratio between an adjusted interest rate expectation corresponding to at least one of the start and end date.

31. The apparatus of claim 29, in which providing the interest rate quote includes submitting an order to an electronic marketplace.

32. The apparatus of claim 19, in which the computing device is caused to:
submit an order for the second financial instrument in response to a determination that the new second rate differs from a rate available on a financial market.

33. The apparatus of claim 19, in which the computing device is caused to:
If the correlation is non-zero, in response to adjusting the second spread, adjust the first rate based on the correlation to maintain the second spread.

34. The apparatus of claim 19, in which determining the correlation includes at least one of receiving a user input correlation, and determining the correlation based on historical data illustrating the correlation.

35. The apparatus of claim 19, in which receiving the first rate includes receiving the first rate from a market data provider.
